(19) United States
(12) Patent Application Publication
(10) Pub. No.: US 2015/0348513 A1
(43) Pub. Date: Dec. 3, 2015

(54) GAZE BASED NOTIFICATION PLACEMENT

(71) Applicant: Lenovo (Singapore) Pte. Ltd., Singapore (SG)

(72) Inventors: Jason Grimme, Cary, NC (US); Manisha Bijjaragi, Mebane, NC (US); Russell Speight VanBlon, Raleigh, NC (US)

(73) Assignee: Lenovo (Singapore) Pte. Ltd., Singapore (SG)

(21) Appl. No.: 14/287,950

(22) Filed: May 27, 2014

(51) Int. Cl. G09G 5/377; G06F 3/01; G09G 5/38

(52) U.S. Cl. CPC G09G 5/377; G09G 5/38; G06F 3/013; G09G 2340/12; G09G 2354/00

(57) ABSTRACT

A method includes obtaining information identifying where a user is looking on a display device, obtaining a notification to display, and placing the notification on the display device based on the determination of where the user is looking on the display device.

### BACKGROUND

Items such as alerts, notification, or advertisements, are often placed on a screen of a device on top of content to deliver a message to a user. Sometimes the item is placed in the middle of the screen, or in a corner of the screen. While a user may notice the items in time, the items may not be noticed immediately, or may never be noticed prior to fading out.

### SUMMARY

A method includes identifying where a user is looking on a display device, obtaining a notification to display, and placing the notification on the display device based on the identifying where the user is looking on the display device.

A machine readable storage device has instructions for execution by a processor of the machine to perform operations including identifying where a user is looking on a display device, obtaining a notification to display, and placing the notification on the display device based on the identifying where the user is looking on the display device.

In a further embodiment, a device includes a display device, a processor operatively coupled to the display device, and a memory device having a program stored thereon for execution by the processor to identify where a user is looking on a display device, obtain a notification to display, and place the notification on the display device based on the identification of where the user is looking on the display device.

### BRIEF DESCRIPTION OF THE DRAWINGS

FIG. 1 is a block diagram of a system to place notifications on a viewing area of a display device according to an example embodiment.

FIG. 2 is a flowchart illustrating a method of placing notifications on a viewing area of a display device according to an example embodiment.

FIG. 3 is a flowchart illustrating a further method of placing notifications on a viewing area of a display device according to an example embodiment.

FIG. 4 is a block diagram of computer system used to implement methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

When using a device having a display, notifications may be placed on the display to inform a user of events. In various embodiments, the notifications are placed on the display in a location that is dependent on where the user is looking, which may be determined using one or more cameras and gaze tracking functionality. The placement of the notification may also be based on the importance or urgency of the notification. Important notifications may be placed to ensure that the user quickly notices the information because the location is where the gaze tracking indicates that the user is currently looking. In the case of multiple displays, the notification may be placed on the display at which the user is looking. If a notification is not urgent, the notification may be placed near where the user is looking, but not interfering with or obscuring what the user is looking at.

Various examples may include a user reading an online news article on a portable tablet device when the battery charge on the device reaches a critical level. A power manager on the device displays a notification on top of the article that the user is reading to ensure that the user sees the notification immediately. In another example, the notification may be placed adjacent to the article in an unobtrusive, but easily noticeable way. In a further example, the user is using a personal computer having multiple monitors, reading an article on one of the monitors. In this case, a power manager may display a notification on the same monitor as the user is reading, even if that monitor is not the primary monitor.

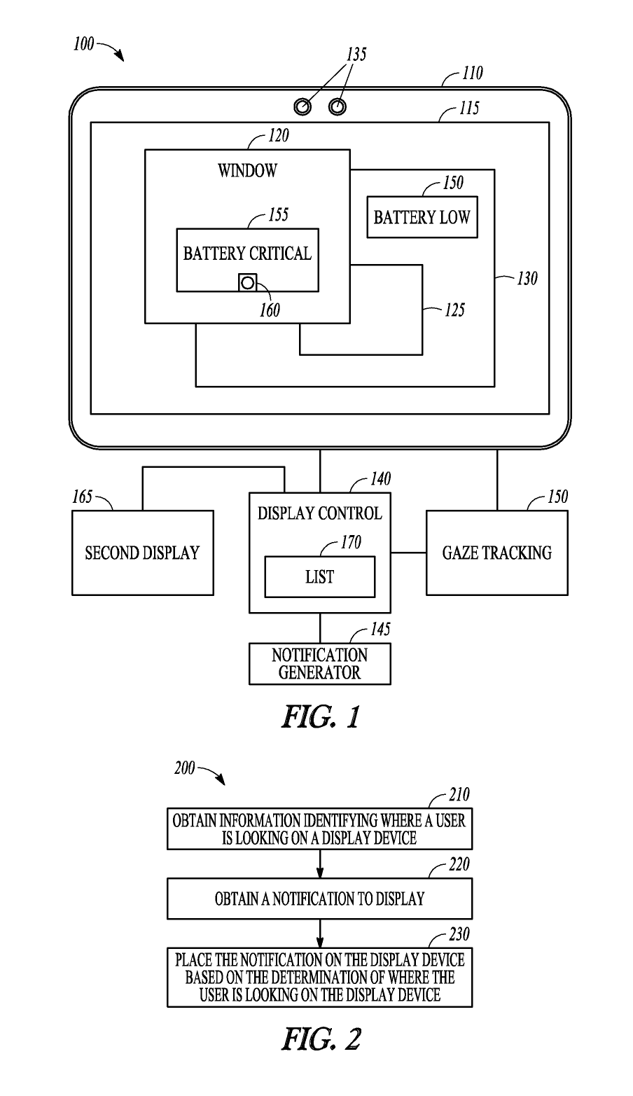

FIG. 1 is a block diagram representation of a notification placement system 100. A display 110 has a viewing area 115 having multiple windows 120, 125, 130 or other areas of content and information corresponding to one or more software programs such as applications, drivers, and an operating system. Display 110 also has one or more front facing cameras 135, which may be used to obtain user gaze information suitable for determining where a user is looking at the viewing area 115.

A display control 140 may be used to drive the display and place information on the viewing area 115. In one embodiment, the display control receives notifications from one or more notification generators 145, which may correspond to the software programs. The notification generator 145 may receive gaze tracking information from a gaze tracking module 150 which is coupled to receive information from the one or more cameras 135. The gaze tracking information may be provided directly to the notification generator 145 or via display control 140 in various embodiments.

Typical notifications may include system alerts, such as a battery low, or battery critical notification usually generated via a power manager separate from or within the operating system. The battery low notification may not be high priority, and may indicate that a certain amount of time is remaining on the battery. A battery critical notification may be high priority and may inform a user that that their battery is about to fail and advise the user to quickly save work to avoid losing the work.

The battery low notification may be placed in the viewing area, to not obscure information being currently viewed by a user. An example is illustrated at 150, where the user is looking at window 120. The battery low indication at 150 does not obscure the content displayed in window 120. The lower priority notification may also be placed in other areas outside of window 120, but near enough to be noticed by the user more quickly than when placed in a corner of the viewing area 115.

Note that the content may not be displayed in windows in some embodiments, so the placement of a lower priority notification may not be as clear cut, but may be based on some logical connection between content on the viewing area so as not to obscure such connected content, yet bring attention of the notification to the user.

A battery critical notification 155 may be placed directly on top of the content being looked at in window 120. In some embodiments, the gaze tracking information may be used to identify precisely where the user is looking, and to actually center the notice at that point. In further embodiments, the notification may be moved to track with the user gaze as the user looks at different parts of the viewing area to ensure the notification is noticed until dismissed by the user by clicking an “OK” button 160 on the notification or pressing an escape key. In further embodiments one or more further displays, such as a second display 165 may also be part of the system 100, and also contain gaze tracking functionality. The notifications may also be placed on such additional display viewing areas as the user looks at them.

In various embodiments, each notification generator 145 may provide placement information to the display control 140 based on the notification generator's assessment of importance and gaze tracking information. In further embodiments, the notification generator 145 may provide the notification and a priority value corresponding to the importance of the notification to the display control, which then receives gaze tracking information and places the notification appropriately in the viewing area 115.

In further embodiments, the notifications may comprise a message from other applications or software about networks, applications, chat messages, phone calls, etc. If the notification generator does not provide a priority, the display control may contain a list 170 of notifications or sources of notifications with associated priorities that are system defaults or modified by a user. Incoming notifications may be matched to the list to obtain a priority and properly place the notification. For instance, a chat message from an important person, such as a family member, or important business contact may appear in the list as a high priority message that should be placed where the user is looking to ensure that it is seen quickly.

In still further embodiments, the display control may also intercept pop-up advertisements and place them where they do not interfere with a viewing area, and allow dismissing them by hitting escape, or selecting a separate dismiss icon or checkbox to avoid selecting an unintended link.

In a further embodiment, the user may be using different computers that are networked together. Each computer may be configured to monitor gaze tracking, and provide updated information to the other computers. A notification originating in one computer may be routed to display on the display of a different computer being gazed at by the user.

FIG. 2 is a flowchart illustration of a method 200 for determining where to display notifications on a viewing area of a display. At 210, information identifying where a user is looking on a display device is obtained. A notification to display is also obtained at 220. The notification to display may be generated by gaze tracking functions on one or more displays available to the user via one or more computers the user is interacting with. At 230, the notification is placed on the display device based on the identification of where the user is looking on the display device.

In one embodiment, the notification is placed proximate wherein the user is looking on the display device so as not to obscure the user's view of the information already being displayed where the user is looking. Placement of the notification may be identified by a program that generated the notification, or by a display controller or driver in different embodiments. The gaze tracking information may be provided by each display the user has available. Multiple different computers used by the user may exchange information with the notification being routed for display to the computer having the display that the user is currently looking at.

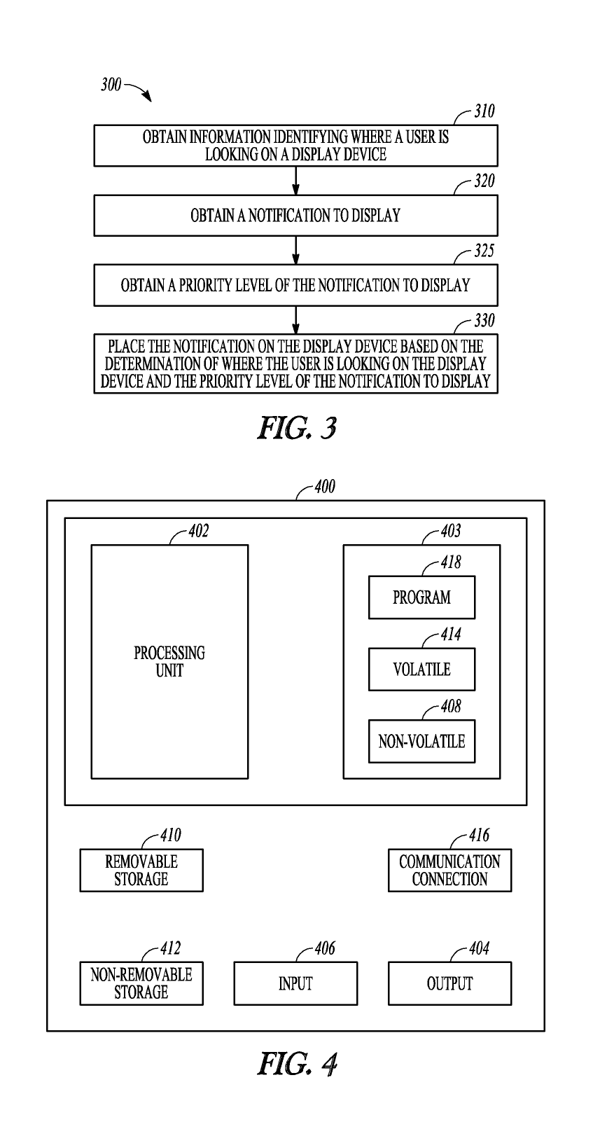

FIG. 3 is a flowchart illustrating a further method of placing notifications on a viewing area of a display. At 310, information identifying where a user is looking on a display device is obtained. A notification to display is also obtained at 320. The notification to display may be generated by gaze tracking functions on one or more displays available to the user via one or more computers the user is interacting with. At 325, a priority level of the notification to display is obtained. The priority level may be provided by the notification generator, or may be determined by the display controller comparing the notification to a list of prioritized notifications to obtain a proper priority for the obtained notification. At 330, the notification is placed on the display device based on the determination of where the user is looking on the display device and the priority level of the notification to display.

In some embodiments, a high priority notification may be placed at 335 where the user is looking regardless of the information already displayed where the user is looking. At 340, the placement of the notification may be updated such that it moves as the user looks at different parts of the display device until notification is dismissed.

In various embodiments, a high priority notification may be a battery level critical notification or a chat message selected from a group of pre-identified high priority senders. Other alerts generated by the system may also be similarly placed.

In some embodiments, methods 200 or 300 may be performed by a software module executing on a computer system, where the software module generates the notification, receives the information identifying where the user is looking at the display from an eye tracking module, and determines where to place the notification on the display. Each application or other notification generation program or module may perform methods 200 or 300 in different embodiments.

FIG. 4 is a block schematic diagram of a computer system 400 to perform one or more methods according to example embodiments. All components need not be used in various embodiments. One example computing device in the form of a computer 400, may include a processing unit 402, memory 403, removable storage 410, and non-removable storage 412. Sensors 115 and 125 may be coupled to provide data to the processing unit 402. Memory 403 may include volatile memory 414 and non-volatile memory 408. Computer 400 may include—or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 400 may include or have access to a computing environment that includes input 406, output 404, and a communication connection 416. Output 404 may include one or more display devices, such as a touchscreen, that also may serve as an input device. The computer may operate in a networked environment using a communication connection to connect to one or more remote computers, such as database servers. The remote computer may include a personal computer (PC), server, router, network PC, a peer device or other common network node, or the like. The communication connection may include a cellular network, Local Area Network (LAN), a Wide Area Network (WAN), cellular network, or other networks.

Computer-readable instructions stored on a computer-readable medium are executable by the processing unit 402 of the computer 400. A hard drive, CD-ROM, and RAM are some examples of articles including a non-transitory computer-readable medium. For example, a computer program 418 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 400 to provide generic access controls in a COM based computer network system having multiple users and servers.

### EXAMPLES

1. A method comprising:
identifying where a user is looking on a display device;
obtaining a notification to display; and
placing the notification on the display device based on the identifying where the user is looking on the display device.

2. The method of example 1 and further comprising obtaining a location of information already being displayed where the user is looking, and wherein the notification is placed proximate to where the user is looking on the display device so as not to obscure the users view of the information already being displayed where the user is looking.

3. The method of any of examples 1-2 and further comprising obtaining a priority level of the notification to display.

4. The method of example 3 wherein placing the notification on the display device includes placing the notification as a function of the priority level of the notification to display.

5. The method of example 4wherein a high priority notification is placed where the user is looking regardless of the information already displayed where the user is looking.

6. The method of example 5 wherein the high priority notification comprises a battery level critical notification.

7. The method of example 5 wherein the high priority notification comprises a chat message selected from a group of pre-identified high priority senders.

8. The method of any of examples 1-7 wherein the display device is selected from multiple display devices of the user.

9. The method of any of examples 1-8 wherein information identifying where a user is looking on a display is provided by an eye tracking module coupled to a user facing camera.

10. The method of any of examples 1-9 wherein the method is performed by a software module executing on a computer system, wherein the software module generates the notification, receives information identifying where the user is looking on the display from an eye tracking module, and determines where to place the notification on the display.

11. A machine readable storage device having instructions for execution by a processor of the machine to perform operations comprising:
identifying where a user is looking on a display device;
obtaining a notification to display; and
placing the notification on the display device based on the identifying where the user is looking on the display device.

12. The machine readable storage device of example 11 and further performing obtaining a location of information already being displayed where the user is looking, and wherein the notification is placed proximate to where the user is looking on the display device so as not to obscure the users view of the information already being displayed where the user is looking.

13. The machine readable storage device of example 12 and further performing obtaining a priority level of the notification to display.

14. The machine readable storage device of example 13 wherein placing the notification on the display device includes placing the notification as a function of the priority level of the notification to display.

15. The machine readable storage device of example 14 wherein a high priority notification is placed where the user is looking regardless of the information already displayed where the user is looking.

16. A device comprising:
a display device;
a processor operatively coupled to the display device; and
a memory device having a program stored thereon for execution by the processor to:
identify where a user is looking on a display device;
obtain a notification to display; and
place the notification on the display device based on the identification of where the user is looking on the display device.

17. The device of example 16 wherein the processor further obtains a location of information already being displayed where the user is looking, and wherein the notification is placed proximate to where the user is looking on the display device so as not to obscure the user's view of the information already being displayed where the user is looking.

18. The device of any of examples 16-17 wherein the processor comprising obtains a priority level of the notification to display wherein placing the notification on the display device includes placing the notification as a function of the priority level of the notification to display.

19. The device of example 18 wherein a high priority notification is placed where the user is looking regardless of the information already displayed where the user is looking, and wherein the high priority notification comprises a battery level critical notification.

20. The device of any of examples 16-19 wherein the program comprises a software module stored on the memory device that when executed by the processor generates the notification, receives the information identifying where the user is looking on the display from an eye tracking module, and determines where to place the notification on the display.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
identifying where a user is looking on a display device;
obtaining a notification to display; and
placing the notification on the display device based on the identifying where the user is looking on the display device.

2. The method of claim 1 and further comprising obtaining a location of information already being displayed where the user is looking, and wherein the notification is placed proximate to where the user is looking on the display device so as not to obscure the users view of the information already being displayed where the user is looking.

3. The method of claim 1 and further comprising obtaining a priority level of the notification to display.

4. The method of claim 3 wherein placing the notification on the display device includes placing the notification as a function of the priority level of the notification to display.

5. The method of claim 4 wherein a high priority notification is placed where the user is looking regardless of the information already displayed where the user is looking.

6. The method of claim 5 wherein the high priority notification comprises a battery level critical notification.

7. The method of claim 5 wherein the high priority notification comprises a chat message selected from a group of pre-identified high priority senders.

8. The method of claim 1 wherein the display device is selected from multiple display devices of the user.

9. The method of claim 1 wherein information identifying where a user is looking on a display is provided by an eye tracking module coupled to a user facing camera.

10. The method of claim 1 wherein the method is performed by a software module executing on a computer system, wherein the software module generates the notification, receives information identifying where the user is looking on the display from an eye tracking module, and determines where to place the notification on the display.

11. A machine readable storage device having instructions for execution by a processor of the machine to perform operations comprising:
identifying where a user is looking on a display device;
obtaining a notification to display; and
placing the notification on the display device based on the identifying of where the user is looking on the display device.

12. The machine readable storage device of claim 11 and further performing obtaining a location of information already being displayed where the user is looking, and wherein the notification is placed proximate to where the user is looking on the display device so as not to obscure the users view of the information already being displayed where the user is looking.

13. The machine readable storage device of claim 12 and further performing obtaining a priority level of the notification to display.

14. The machine readable storage device of claim 13 wherein placing the notification on the display device includes placing the notification as a function of the priority level of the notification to display.

15. The machine readable storage device of claim 14 wherein a high priority notification is placed where the user is looking regardless of the information already displayed where the user is looking.

16. A device comprising:
a display device;
a processor operatively coupled to the display device; and
a memory device having a program stored thereon for execution by the processor to:
identify where a user is looking on the display device;
obtain a notification to display; and
place the notification on the display device based on the identification of where the user is looking on the display device.

17. The device of claim 16 wherein the processor further obtains a location of information already being displayed where the user is looking, and wherein the notification is placed proximate to where the user is looking on the display device so as not to obscure the user's view of the information already being displayed where the user is looking.

18. The device of claim 16 wherein the processor comprising obtains a priority level of the notification to display wherein placing the notification on the display device includes placing the notification as a function of the priority level of the notification to display.

19. The device of claim 18 wherein a high priority notification is placed where the user is looking regardless of the information already displayed where the user is looking, and wherein the high priority notification comprises a battery level critical notification.

20. The device of claim 16 wherein the program comprises a software module stored on the memory device that when executed by the processor generates the notification, receives the information identifying where the user is looking on the display from an eye tracking module, and determines where to place the notification on the display.
